(19) United States
(12) Patent Application Publication
(10) Pub. No.: US 2006/0109395 A1
(43) Pub. Date: May 25, 2006

(54) Area light source device and liquid crystal display device including the same

(76) Inventors: Junya Yamamoto, Kanazawa-shi (JP); Keiko Nishi, Hakusan-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/282,887

(22) Filed: Nov. 21, 2005

(30) Foreign Application Priority Data
Nov. 24, 2004 (JP) 2004-339057

(51) Int. Cl. G02F 1/1333

(52) U.S. Cl. 349/58

(57) ABSTRACT

An area light source device includes a light source, a light guide having an incidence surface on which radiation light from the light source is incident, and a first major surface and a second major surface, which are opposed to each other and from which incident light coming in through the incidence surface is emitted, a reflective layer disposed on the second major surface side of the light guide, a diffusion layer that is disposed on the first major surface side of the light guide and is constructed by stacking a plurality of diffusion sheets, and a lens layer that is disposed on the diffusion layer.

### CROSS-REFERENCE TO RELATED APPLICATIONS

This application is based upon and claims the benefit of priority from prior Japanese Patent Application No. 2004-339057, filed Nov. 24, 2004, the entire contents of which are incorporated herein by reference.

### BACKGROUND OF THE INVENTION

1. Field of the Invention

The present invention relates generally to an area light source device and a liquid crystal display device that includes the area light source device, and more particularly to an area light source device that illuminates a liquid crystal display panel, and to a liquid crystal display device including the area light source device.

2. Description of the Related Art

Liquid crystal display devices have been applied to various fields as display devices for, e.g. OA equipment such as computers and TVs, taking advantage of their features of light weight, small thickness and low power consumption. In recent years, the liquid crystal display devices have also been used as display devices of mobile terminals such as mobile phones. This type of liquid crystal display device includes, for example, a transmissive liquid crystal display panel and a backlight device that illuminates the back side of the liquid crystal display panel.

As regards the liquid crystal display device with this structure, the luminance of an image, which is displayed on the liquid crystal display device, can be enhanced by improving the efficiency of use of radiation light from the backlight device. For example, there have been proposed a backlight system and a display device, to which a brightness enhancement film with a prism (e.g. BEF manufactured by 3M Limited) is applied (see Jpn. Pat. Appln. KOKAI Publication No. 11-167809 and PCT National Publication No. 10-510371, for instance).

In the above-mentioned liquid crystal display device to which the brightness enhancement film is applied, the luminance in the normal direction to the liquid crystal display panel can be enhanced. However, the luminance in viewing-angle directions different from the normal direction cannot adequately be enhanced. In other words, the range of viewing angles, within which high-luminance images can be displayed, is narrow.

### BRIEF SUMMARY OF THE INVENTION

The present invention has been made in consideration of the above-described problem, and the object of the invention is to provide an area light source device capable of realizing a wide viewing angle of a liquid crystal display panel that is an object of illumination, and a liquid crystal display device including the area light source device.

According to a first aspect of the present invention, there is provided an area light source device comprising: a light source; a light guide having an incidence surface on which radiation light from the light source is incident, and a first major surface and a second major surface, which are opposed to each other and from which incident light coming in through the incidence surface is emitted; a reflective layer that is disposed on the second major surface side of the light guide and has light reflectivity; a diffusion layer that is disposed on the first major surface side of the light guide and is constructed by stacking a plurality of diffusion sheets with light diffusing properties; and a lens layer that is disposed on the diffusion layer.

According to a second aspect of the present invention, there is provided a liquid crystal display device comprising: a liquid crystal display panel including an effective display section in which a plurality of display pixels are arranged; and an area light source device that illuminates the liquid crystal display panel, the area light source device including: a light source; a light guide having an incidence surface on which radiation light from the light source is incident, and a first major surface and a second major surface, which are opposed to each other and from which incident light coming in through the incidence surface is emitted; a reflective layer that is disposed on the second major surface side of the light guide and has light reflectivity; a diffusion layer that is disposed on the first major surface side of the light guide and is constructed by stacking a plurality of diffusion sheets with light diffusing properties; and a lens layer that is disposed on the diffusion layer.

The present invention can provide an area light source device capable of realizing a wide viewing angle of a liquid crystal display panel that is an object of illumination, and a liquid crystal display device including the area light source device.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exploded perspective view that schematically shows the structure of a liquid crystal display device according to an embodiment of the present invention;

FIG. 2 is an exploded perspective view that schematically shows the structure of a backlight unit, which is mounted on the liquid crystal display device shown in FIG. 1;

FIG. 3 is a cross-sectional view that schematically shows the structure of the liquid crystal display device shown in FIG. 1;

FIG. 4 schematically shows an example of the shape of a lens layer that is applied to the backlight unit shown in FIG. 2;

FIG. 5 shows a measurement result relating to a viewing-angle distribution of luminance in a horizontal direction of a backlight unit that is applicable to the liquid crystal display device shown in FIG. 1;

FIG. 6 shows a measurement result relating to a viewing-angle distribution of luminance in a vertical direction of a backlight unit that is applicable to the liquid crystal display device shown in FIG. 1;

FIG. 7A shows a measurement result relating to a viewing-angle distribution of luminance in a vertical direction of a backlight unit in which a second optical function layer is composed of a single diffusion sheet;

FIG. 7B is a view for explaining a luminance peak direction in a diffusion sheet and a lens layer in the backlight unit in which the second optical function layer is composed of the single diffusion sheet;

FIG. 8A shows a measurement result relating to a viewing-angle distribution of luminance in a vertical direction of a backlight unit in which a second optical function layer is composed of two diffusion sheets;

FIG. 8B is a view for explaining a luminance peak direction in diffusion sheets and a lens layer in the backlight unit in which the second optical function layer is composed of the two diffusion sheets;

FIG. 9A shows a measurement result relating to a viewing-angle distribution of luminance in a vertical direction of a backlight unit in which a second optical function layer is composed of three diffusion sheets;

FIG. 9B is a view for explaining a luminance peak direction in diffusion sheets and a lens layer in the backlight unit in which the second optical function layer is composed of the three diffusion sheets;

FIG. 10 shows an example of a measurement result for explaining an optimal range of haze values of a diffusion sheet; and

FIG. 11 shows an example of a measurement result for explaining an optimal range of angles formed between a direction of extension of prism shapes and a major radiation direction of a light source.

### DETAILED DESCRIPTION OF THE INVENTION

An area light source device according to an embodiment of the present invention and a liquid crystal display device including the area light source device will now be described with reference to the accompanying drawings. Specifically, a description is given of a transmissive liquid crystal display device that selectively passes backlight from an area light source device, such as a backlight unit, and displays an image.

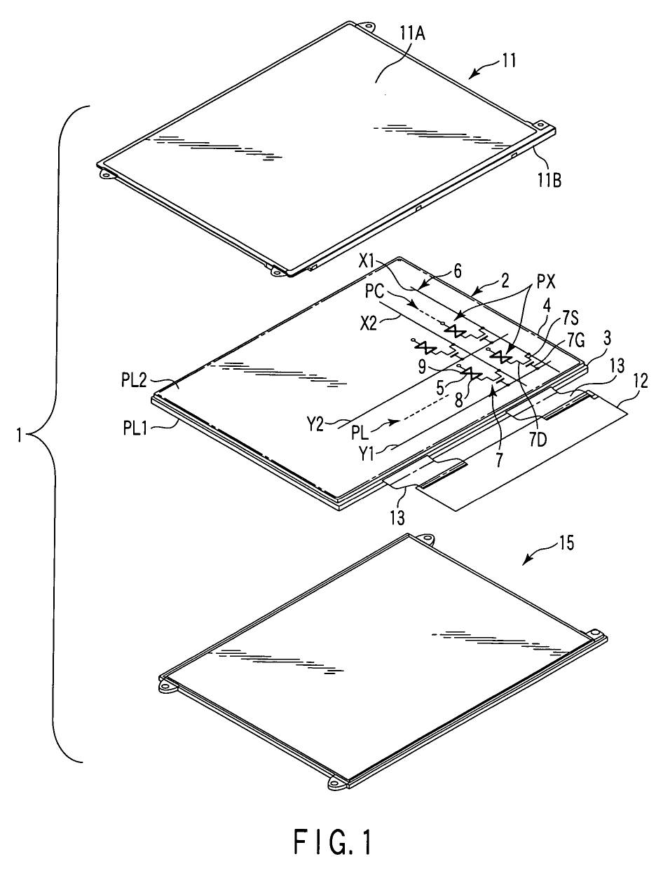

As is shown in FIG. 1, a liquid crystal display device 1 includes a substantially rectangular, planar transmissive liquid crystal display panel 2, and a backlight unit 15 that illuminates the liquid crystal display panel 2. The liquid crystal display panel 2 is configured such that a liquid crystal layer is held between a pair of substrates. Specifically, the liquid crystal display panel 2 includes a rectangular array substrate 3, a rectangular counter-substrate 4, and a liquid crystal layer 5 that serves as an optical modulation layer and is sealed between these paired substrates. The array substrate 3 and counter-substrate 4 are bonded via a seal material. The liquid crystal display panel 2 includes an effective display section 6 that displays an image.

The effective display section 6 is composed of a plurality of display pixels PX that are arranged in a matrix. Specifically, the effective display section 6 includes pixel rows PL of display pixels PX that are arranged in rows in a first direction, and pixel columns PC of display pixels PX that are arranged in columns in a second direction perpendicular to the first direction.

The array substrate 3 includes a plurality of scan lines Y (1, 2, 3, . . . , m), a plurality of signal lines X (1, 2, 3, . . . , n), switching elements 7 that are arranged in association with the respective display pixels PX, and pixel electrodes 8 that are connected to the switching elements 7.

Each of the scan lines Y extends in parallel to the row direction of display pixels PX, that is, the first direction. Each of the signal lines X extends in parallel to the column direction of display pixels PX, that is, the second direction, so as to cross the scan lines Y. The switching elements 7 are disposed near intersections between the scan lines Y and signal lines X.

The switching element 7 is formed of, e.g. a thin-film transistor (TFT), which includes a semiconductor layer formed of, e.g. an amorphous silicon film or a polysilicon film. The switching element 7 has a gate electrode 7G that is electrically connected to the associated scan line Y (or formed integral with the scan line). The switching element 7 has a source electrode 7S that is electrically connected to the associated signal line X (or formed integral with the signal line). The switching element 7 has a drain electrode 7D that is electrically connected to the pixel electrode 8 of the associated display pixel PX.

The counter-substrate 4 includes a counter-electrode 9 that is common to all the display pixels PX in the effective display section 6. The pixel electrodes 8 and counter-electrode 9 are formed of an electrically conductive material with light transmissivity such as ITO (indium tin oxide) or IZO (indium zinc oxide). The array substrate 3 and counter-substrate 4 are disposed such that the pixel electrodes 8 are opposed to the counter-electrode 9, and a gap is provided therebetween. The liquid crystal layer 5 is formed of a liquid crystal composition that is sealed in the gap between the array substrate 3 and counter-substrate 4.

In the liquid crystal display panel 2, a pair of polarizer plates PL1 and PL2, whose directions of polarization are set in accordance with the characteristics of the liquid crystal layer 5, are provided on the outer surface of the array substrate 3 and the outer surface of the counter-substrate 4.

In a color display type liquid crystal display device, the liquid crystal display panel 2 includes a plurality of kinds of display pixels, for instance, a red pixel that displays red (R), a green pixel that displays green (G), and a blue pixel that displays blue (B). Specifically, the red pixel includes a red color filter that passes light with a principal wavelength of red. The green pixel includes a green color filter that passes light with a principal wavelength of green. The blue pixel includes a blue color filter that passes light with a principal wavelength of blue. These color filters are disposed on a major surface of the array substrate 3 or counter-substrate 4.

The liquid crystal display device may, in some cases, include a bezel cover 11 having a rectangular frame-like shape. In the case where the bezel cover 11 is provided, the bezel cover 11 includes a rectangular window section 11A that exposes the effective display section 6 of the liquid crystal display panel 2, and a main body 11B that has a rectangular frame-like shape and defines the window section 11A. The liquid crystal display panel 2 with the above-described structure is held between the backlight unit 15 and the bezel cover 11. Specifically, the backlight 15, together with the liquid crystal display panel 2, is formed integral with the bezel cover 11 in the state in which the upper surface of the backlight 15 is opposed to the back surface (array substrate-side surface) of the liquid crystal display panel 2. The backlight 15 illuminates the back side of the liquid crystal display panel 2. For example, in a case where the backlight unit 15 and the liquid crystal display panel 2 are fixed by a double-side adhesive tape, the bezel cover 11 is not necessarily required.

Further, the liquid crystal display device includes a driver circuit 12, which supplies a drive signal to the liquid crystal display panel 2. The driver circuit 12 has, e.g. an elongated rectangular, planar shape, and is electrically connected to one side edge of the liquid crystal display panel 2 via a flexible printed circuit board 13. The driver circuit 12 can be positioned on the back side of the backlight 15 by bending the printed circuit board 13.

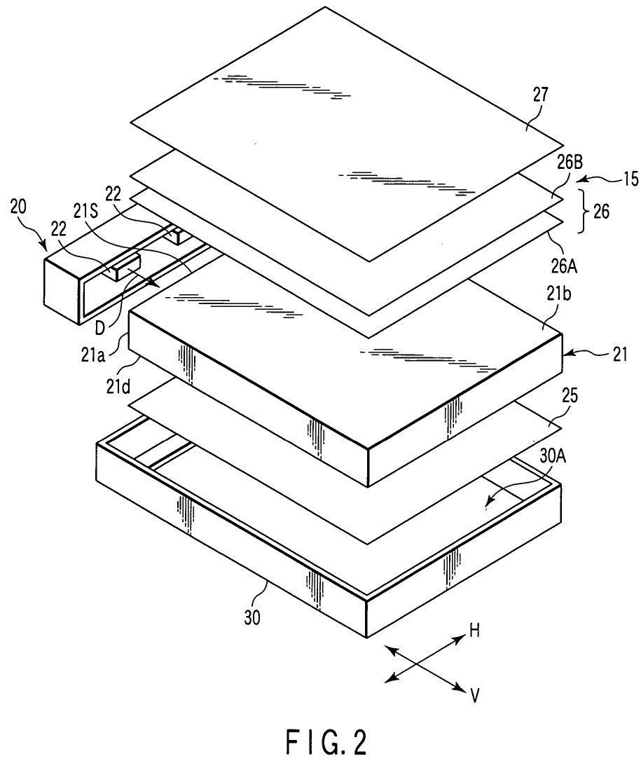

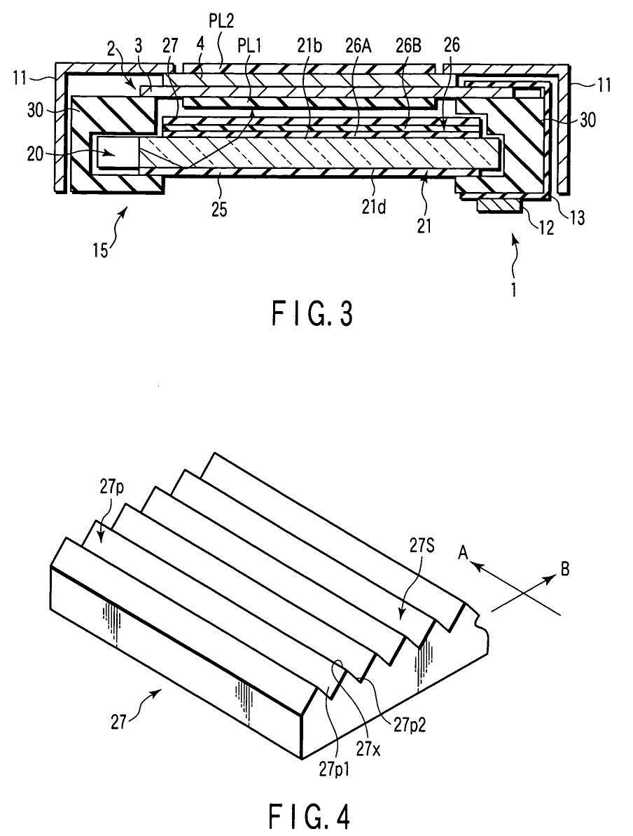

As is shown in FIGS. 2 and 3, the backlight unit 15 includes a light source unit 20 and a light guide 21. The light source unit 20 comprises, for instance, point light sources 22 as light sources. The point light source 22 is composed of a white light-emitting diode. The white light-emitting diode, which is applicable to this embodiment, may be a diode unit in which a red light-emitting diode, a green light-emitting diode and a blue light-emitting diode are combined and packaged, or a diode unit in which a blue light-emitting diode or an ultraviolet emitting diode is combined with a phosphor. The radiation light from the white light-emitting diode is radiated in its major radiation direction. The radiation light may include a light component that is diverged at a predetermined divergence angle with respect to the major radiation direction. The major radiation direction corresponds to a direction in which the radiation light from the light-emitting diode 22 takes a maximum intensity value.

In this embodiment, the light source unit 20 includes a plurality of light-emitting diodes 22. The light source unit 20 includes a support base plate that supports the plural light-emitting diodes 22 at predetermined positions, and a driving circuit for driving these light-emitting diodes 22.

The light guide 21 converts radiation light from the light-emitting diodes 22 to planar light and emits the planar light. Specifically, the light guide 21 is formed of a light transmissive resin material such as an acrylic resin or a polycarbonate resin. The light guide 21 may have a wedge-like plate shape with a thin part at one end and a thick part at the other end that is opposed to the thin part, or may have a flat-plate shape with a substantially uniform thickness over the entirety thereof. In this embodiment, the light guide 21 has a flat-plate shape. The thickness of the light guide 21, in this context, corresponds to a height in a direction normal to a first major surface 21b. The light guide 21 includes the substantially rectangular first major surface 21b that faces the liquid crystal display panel 2; a substantially rectangular second major surface 21d that is opposed to the first major surface 21b; and substantially rectangular first side surface 21a and second side surface 21c that connect the first major surface 21b and second major surface 21d.

In this embodiment, the light source unit 20 is disposed along a short side 21S of the light guide 21. Specifically, the light-emitting diodes 22 are arranged so as to face the first side surface 21a that extends along the short side 21S of the light guide 21. The first side surface 21a of the light guide 21 corresponds to a light incidence surface on which radiation light from the light-emitting diodes 22 is incident. In this case, the light-emitting diodes 22 are disposed such that their major radiation direction D is substantially parallel to the normal direction of the first side surface 21a (for example, the positional relationship between the emission surfaces of the light-emitting diodes 22 and the first side surface 21a is set such that they are substantially parallel). Thereby, most of radiation light from the light-emitting diodes 22 is made directly incident on the incidence surface 21a.

In the light guide 21 with the above described structure, radiation light from the light-emitting diodes 22, which comes in through the first side surface 21a, propagates within the light guide 21. Then, the light can be emitted from the first major surface 21b and second major surface 21d. In other words, the first major surface 21b and second major surface 21d of the light guide 21 correspond to emission surfaces from which the incident light, which enters the light guide 21, is emitted.

The backlight unit 15 includes a plurality of optical function layers that impart predetermined optical characteristics to emission light from the light guide 21. Specifically, the backlight unit 15 includes a first optical function layer 25 that is disposed on the second major surface 21d side of the light guide 21. The first optical function layer 25 is a reflective layer with a function of reflecting light, which leaks out from the second major surface 21d of the light guide 21, back toward the first major surface 21b of the light guide 21. In this embodiment, the first optical function layer 25 is composed of a reflective sheet that has, on its surface facing the second major surface 21d of the light guide 21, a reflective layer with light reflectivity. The first optical function layer 25 is formed in a substantially rectangular shape with a size substantially equal to the size of the second major surface 21d.

The backlight unit 15 also includes a second optical function layer 26 that is disposed on the first major surface 21b side of the light guide 21. The second optical function layer 26 is a diffusion layer with a function of diffusing emission light from the first major surface 21b of the light guide 21. In this embodiment, the second optical function layer 26 comprises a stacked structure of a plurality (e.g. two) of diffusion sheets 26A and 26B with light diffusion properties. The stacked structure is disposed to be opposed to the first major surface 21b of the light guide 21. The second optical function layer 26 is formed in a substantially rectangular shape with a size substantially equal to the size of the first major surface 21b. The diffusion sheets 26A and 26B are separate sheets that are independent from each other, and when the diffusion sheets 26A and 26B are stacked, an air layer is provided therebetween.

Further, the backlight unit 15 includes a third optical function layer 27 that is disposed on the second optical function layer 26. The third optical function layer 27 is a lens layer with a function of collecting diffused light emanating from the second optical function layer 26. In this embodiment, as shown in FIG. 4, the third optical function layer 27 is composed of a lens sheet that has a prism surface 27S on a side thereof facing the second optical function layer 26, or on a side thereof opposed to this side. The third optical function layer 27 is formed in a substantially rectangular shape with a size substantially equal to the size of the second optical function layer 26.

The prism surface 27S of the third optical function layer 27 is formed by juxtaposing a plurality of prism shapes 27p. Each prism shape 27p extends in a first direction A, and has an apex-angle portion 27x extending in the first direction A. The apex-angle portion 27x corresponds to an intersection between two flat surfaces 27p1 and 27p2 that define the prism shape 27p. The prism shapes 27p are arranged in a second direction B perpendicular to the first direction A.

The optical elements, such as the light source unit 20, light guide 21, first optical function layer 25, second optical function layer 26 and third optical function layer 27, are received and held by a hold frame 30 with a substantially rectangular frame-like shape. The hold frame 30 is formed of a resin, etc. The hold frame 30 includes a recess portion 30A that can receive the above-mentioned optical elements.

The liquid crystal display device with the above-described structure operates as follows. Electric energy is supplied to the light-emitting diodes 22 of the light source unit 20, thereby turning on light-emitting diodes 22. Principal radiation light from the light-emitting diodes 22 is incident on the first side surface 21a of the light guide 21. The incident light coming in through the first side surface 21a propagates through the inside of the light guide 21 and is refracted or reflected toward the first major surface 21b and second major surface 21d of the light guide 21. The emission light from the second major surface 21d of the light guide 21 is reflected by the first optical function layer 25 and guided back into the inside of the light guide 21.

The light that propagates through the inside of the light guide 21 is emitted from the first major surface 21b of the light guide 21. The emission light from the first major surface 21b is incident on the second optical function layer 26. While passing through the second optical function layer 26, the light is properly diffused. The diffusion light emerging from the second optical function layer 26 is incident on the third optical function layer 27. This incident light is properly collected through the third optical function layer 27. Thereby, the luminance of the emission light from the first major surface 21b of the light guide 21 is enhanced and made uniform.

The illumination light from the backlight unit 15, that is, the light emerging from the third optical function layer 27, is led out to the back side of the liquid crystal display panel 2. The illumination light that is led out to the liquid crystal display panel 2 selectively passes through the effective display section 6 of the liquid crystal display panel 2. In other words, in the effective display section 6, the transmission/non-transmission of the illumination light, which is guided to the respective display pixels PX, is selectively controlled. Thereby, an image is displayed on the effective display section 6 of the liquid crystal display panel 2.

As has been described above, the backlight unit 15 includes the diffusion sheet with diffusion properties and the lens sheet with light collecting properties in order to enhance the luminance of emission light and to uniformize the emission light. With this structure, the luminance in the normal direction can be enhanced. Further, in order to sufficiently enhance the luminance in viewing-angle directions different from the normal direction, that is, in order to realize a wide viewing angle, it is effective to apply the second optical function layer that is composed of a stacked structure of a plurality of diffusion sheets.

Assume now that a direction in which the light-emitting diodes 22 of the light source unit 20 are arranged, that is, a direction in which the first side surface 21a functioning as the light incidence surface extends, is a horizontal direction H; the major radiation direction D of the light-emitting diodes 22, that is, the normal direction to the first side surface 21a, is a vertical direction V; and the horizontal direction H and vertical direction V intersect at right angles with each other.

As regards a plurality of kinds of backlight units 15 with different structures of the second optical function layer 26, the luminance (cd/m²) at respective viewing angles (deg.) with respect to the normal direction was measured. A backlight unit A includes a second optical function layer 26 that is composed of a single diffusion sheet. A backlight unit B includes a second optical function layer 26 that is composed of a stacked structure of two diffusion sheets. A backlight unit C includes a second optical function layer 26 that is composed of a stacked structure of three diffusion sheets. The measurement of the luminance was conducted by means of a luminance meter. The same conditions were set for the other optical components, and a BEF (manufactured by 3M Limited) was used as the lens layer that constitutes the third optical function layer 27.

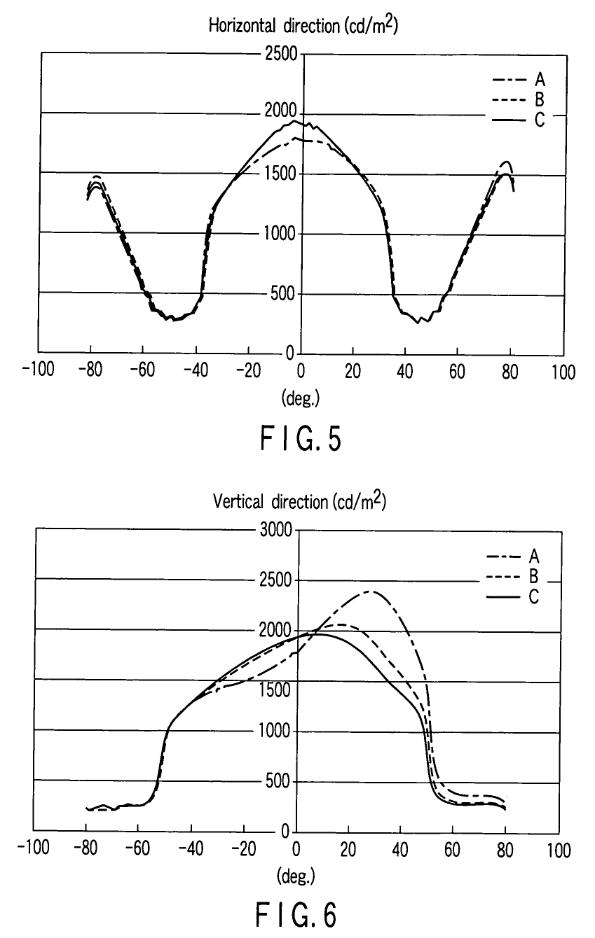

FIG. 5 is a graph that shows a measurement result of the viewing-angle distribution of luminance in the horizontal direction H, and FIG. 6 is a graph that shows a measurement result of the viewing-angle distribution of luminance in the vertical direction V. As is clear from FIG. 5 and FIG. 6, compared to the case (A) where the second optical function layer including only the single diffusion sheet was applied, a higher luminance was obtained in the normal direction (0°) and a higher luminance was obtained in a wider range of viewing angles in the case (B) where the second optical function layer including the stacked structure of two diffusion sheets was applied and in the case (C) where the second optical function layer including the stacked structure of three diffusion sheets was applied.

For example, in the viewing-angle distribution in the vertical direction that is shown in FIG. 6, the luminance in the normal direction was 1924 cd/m² in the case (B), and was 1932 cd/m² in the case (C), which was substantially equal to the case (B) (i.e. relative luminance of 1.00 in relation to case (B)). On the other hand, the luminance in the normal direction was 1787 cd/m² in the case (A) (i.e. relative luminance of 0.93 in relation to case (B)). In short, by adopting the stacked structure of the plural diffusion sheets, the luminance in the normal direction of the backlight unit 15 was increased by about 10%. In the cases (B) and (C), no sharp decrease in luminance was observed in a viewing-angle direction that inclines by about 30° relative to the normal direction, and a higher luminance was generally obtained than in the case (A) in a range of 0°±30°.

It was confirmed that a higher luminance and a wider viewing angle were obtained according to the backlight unit including the second optical function layer 26 that is composed of a plurality of diffusion sheets, compared to the backlight unit including the second optical function layer 26 that is composed of a single diffusion sheet.

The measurement result of the luminance in the case (B) where the second optical function layer 26 is composed of two diffusion sheets was compared with the case (C) where the second optical function layer 26 is composed of three diffusion sheets. It was confirmed that substantially equal characteristics were obtained. In other words, although the use of the stacked structure of plural diffusion sheets can enhance the luminance in a wide range of angles with respect to the normal direction, even if the number of stacked diffusion sheets is increased, no further enhancement in luminance is hardly expected and this would lead to an increase in manufacturing cost and an increase in thickness of the whole apparatus. It is desirable, therefore, that the number of diffusion sheets of the second optical function layer 26 be two. Thereby, the reduction in cost and thickness can be realized while a higher luminance and a wider viewing angle can be obtained.

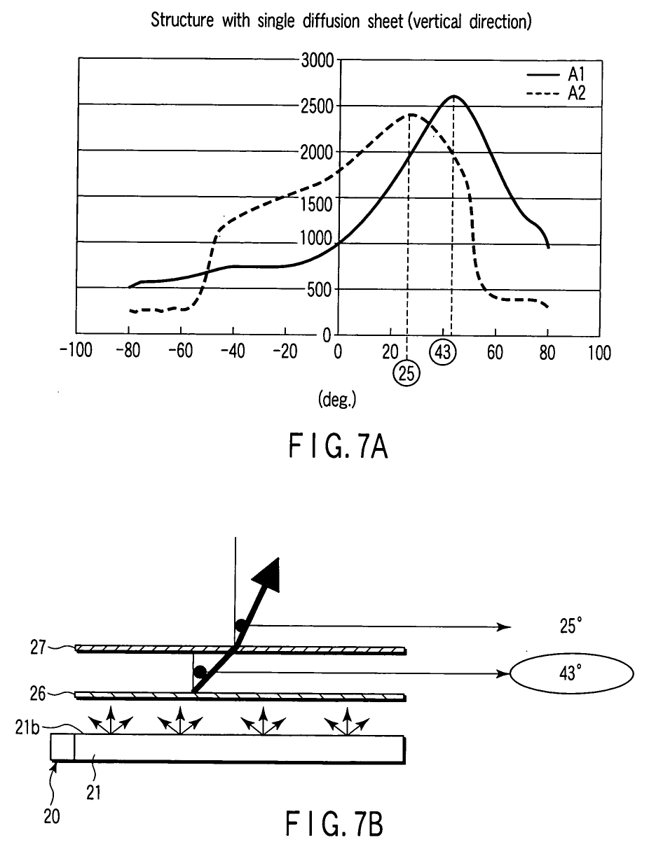

The inventors conducted further studies relating to the above-described results. FIG. 7A shows a measurement result of the viewing-angle distribution of luminance in the vertical direction V of the backlight unit (A) including the second optical function layer 26 that is composed of the single diffusion sheet. A case (A1) where the third optical function layer 27 functioning as the lens layer is not provided was compared with a case (A2) where the third optical function layer 27 is provided.

As is clear from the measurement result shown in FIG. 7A, a peak of luminance is present in a viewing-angle direction at about 43° to the normal direction in the case (A1) where only the second optical function layer 26 is provided on the emission surface 21b side of the light guide 21. Specifically, as shown in FIG. 7B, a light component of emission light from the light guide 21, which passes through the single diffusion sheet, is mainly guided in a viewing-angle direction at an angle of about 43°.

On the other hand, in the case (A2) where the second optical function layer 26 and third optical function layer 27 are disposed on the emission surface 21b side of the light guide 21, a peak of luminance is present in a viewing-angle direction at about 25° to the normal direction. Specifically, as shown in FIG. 7B, incident light, which is principally incident on the third optical function layer 27 at an incidence angle of 43°, passes through the third optical function layer 27 and is mainly guided in a viewing-angle direction at about 25°.

In the case where the second optical function layer 26 is composed of the single diffusion sheet, the range of viewing angles, at which high luminance is obtained, is narrow, and the peak of luminance greatly deviates from the normal direction (i.e. the luminance in the normal direction cannot sufficiently be enhanced). Moreover, the peak luminance at about 25° in the case (A2) is lower than the peak luminance at about 43° in the case (A1), and the effect of the lens layer (third optical function layer 27) cannot fully be exhibited.

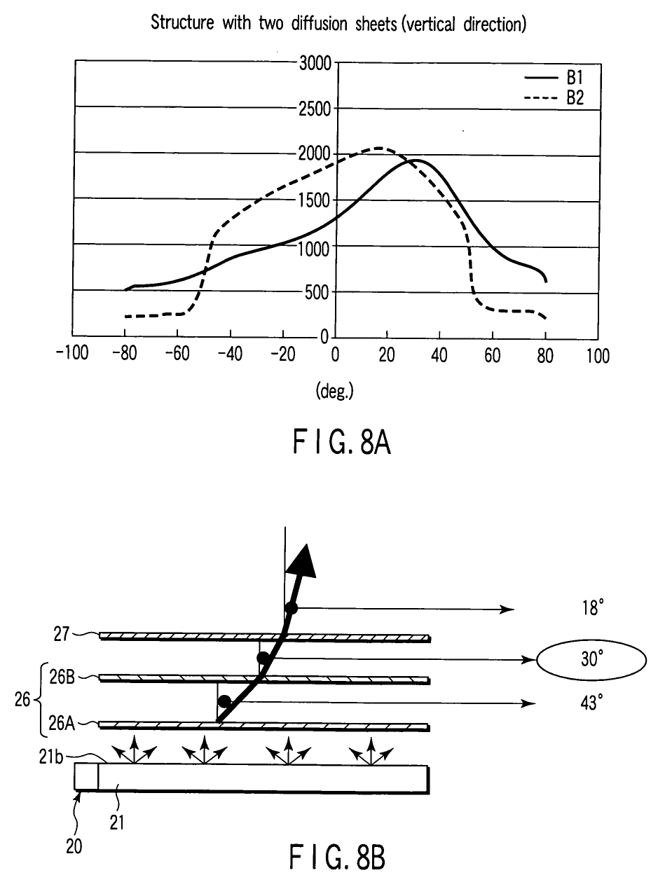

FIG. 8A shows a measurement result of the viewing-angle distribution of luminance in the vertical direction V of the backlight unit (B) including the second optical function layer 26 that is composed of two diffusion sheets. A case (B1) where the third optical function layer 27 functioning as the lens layer is not provided was compared with a case (B2) where the third optical function layer 27 is provided.

As is clear from the measurement result shown in FIG. 8A, a peak of luminance is present in a viewing-angle direction at about 30° to the normal direction in the case (B1) where only the second optical function layer 26 is provided on the emission surface 21b side of the light guide 21. Specifically, as shown in FIG. 8B, a light component of emission light from the light guide 21, which passes through the diffusion sheet 26A, is mainly guided in a viewing-angle direction at an angle of about 43°. Further, the light that emerges from the diffusion sheet 26B is mainly guided in a viewing-angle direction at an angle of about 30°. In other words, the light that passes through the second optical function layer 26 undergoes the effect of the refractive index of an air layer lying between the diffusion sheets 26A and 26B, and tends to be easily guided in a viewing-angle direction that is closer to the normal direction. As a result, in the case where the second optical function layer is composed of the two diffusion sheets, compared to the case where the second optical function layer is composed of the single diffusion sheet, the peak of luminance can be shifted to a viewing-angle direction that is closer to the normal direction.

On the other hand, in the case (B2) where the second optical function layer 26 and third optical function layer 27 are disposed on the emission surface 21b side of the light guide 21, a peak of luminance is present in a viewing-angle direction at about 18° to the normal direction. Specifically, as shown in FIG. 8B, incident light, which is principally incident on the third optical function layer 27 at an incidence angle of 30°, passes through the third optical function layer 27 and is mainly guided in a viewing-angle direction at about 18°.

In the case where the second optical function layer 26 is composed of the two diffusion sheets, compared to the case where the second optical function layer 26 is composed of the single diffusion sheet, the range of viewing angles, at which high luminance is obtained, is increased, and the peak of luminance is shifted to the viewing-angle direction closer to the normal direction. Moreover, the peak luminance at about 18° in the case (B2) is higher than the peak luminance at about 30° in the case (B1), and the viewing-angle range for obtaining high luminance in the case (B2) is wider than that in the case (B1). In short, the principal incidence angle of light that is incident on the lens layer (third optical function layer 27) can be optimized, and the effect of the lens layer can fully be exhibited.

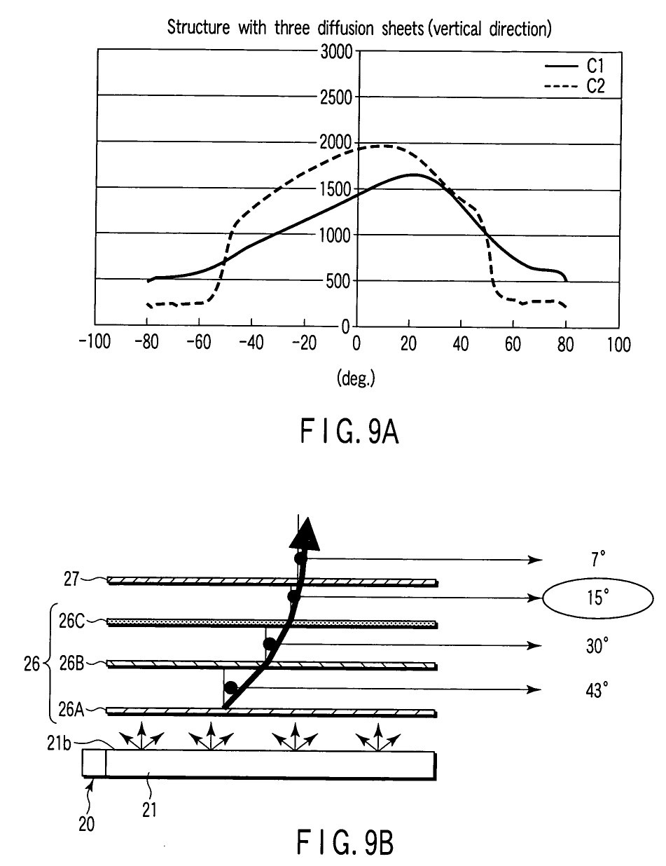

FIG. 9A shows a measurement result of the viewing-angle distribution of luminance in the vertical direction V of a backlight unit (C) including a second optical function layer 26 that is composed of three diffusion sheets. A case (C1) where the third optical function layer 27 functioning as the lens layer is not provided was compared with a case (C2) where the third optical function layer 27 is provided.

As is clear from the measurement result shown in FIG. 9A, a peak of luminance is present in a viewing-angle direction at about 15° to the normal direction in the case (C1) where only the second optical function layer 26 is provided on the emission surface 21b side of the light guide 21. Specifically, as shown in FIG. 9B, a light component of emission light from the light guide 21, which passes through the diffusion sheet 26A, is mainly guided in a viewing-angle direction at an angle of about 43°. The light that emerges from the diffusion sheet 26B is mainly guided in a viewing-angle direction at an angle of about 30°. Further, the light that emanates from the diffusion sheet 26C is mainly guided in a viewing-angle direction at an angle of about 15°.

On the other hand, in the case (C2) where the second optical function layer 26 and third optical function layer 27 are disposed on the emission surface 21b side of the light guide 21, a peak of luminance is present in a viewing-angle direction at about 7° to the normal direction. Specifically, as shown in FIG. 9B, incident light, which is principally incident on the third optical function layer 27 at an incidence angle of 15°, passes through the third optical function layer 27 and is mainly guided in a viewing-angle direction at about 7°.

In the case where the second optical function layer 26 is composed of the three diffusion sheets, compared to the case where the second optical function layer 26 is composed of the single diffusion sheet, the range of viewing angles, at which high luminance is obtained, is increased, and the peak of luminance is further shifted to the viewing-angle direction closer to the normal direction. Moreover, the peak luminance at about 7° in the case (C2) is higher than the peak luminance at about 15° in the case (C1), and the viewing-angle range for obtaining high luminance in the case (C2) is wider than that in the case (C1). In short, the principal incidence angle of light that is incident on the lens layer (third optical function layer 27) can be optimized, and the effect of the lens layer can fully be exhibited.

It is understood, from the above results, that the principal incidence angle of light that is incident on the lens layer needs to be optimized in order to realize a higher luminance and a wider viewing angle. Specifically, with the structure in which only the single diffusion sheet is provided, the viewing angle range for obtaining high luminance is narrow, as is clear from the result of the case (A1), and the viewing-angle direction at which the peak luminance is obtained does not correspond to the optimal incidence angle of the lens layer. Thus, even if the lens layer is added to the whole structure, the luminance decreases, as is clear from the result of the case (A2).

On the other hand, with the structure in which the plural diffusion sheets are stacked, the viewing-angle direction of the peak luminance can be controlled by the combination of these diffusion sheets, and the viewing-angle direction at which the peak luminance is obtained can be made to correspond to the optimal incidence angle of the lens layer. Therefore, by combining the second optical function layer 26 including the stacked structure of the plural diffusion sheets with the third optical function layer 27 functioning as the lens layer, a higher luminance can be obtained and a viewing-angle range, within which high luminance is obtained can be increased. On the basis of the above-described results, it is preferable to set the range of about 15° to 30° as an optimal condition for the principal incidence angle of light that is incident on the third optical function layer 27.

It is preferable that the diffusion sheets 26A, 26B and 26C of the second optical function layer 26 have desirable diffusion properties in order to control the principal incidence angle of light that is incident on the lens layer. The degree of diffusion properties is referred to as “haze value” in the following description.

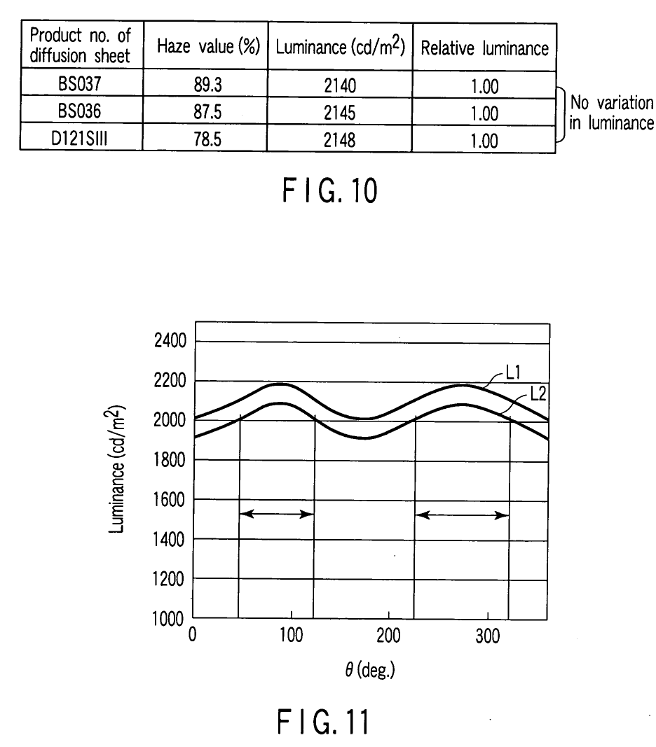

As is shown in FIG. 10, according to a backlight unit 15 that is constructed by stacking two diffusion sheets 26A and 26B having diffusion properties with a haze value of 89.3%, the luminance in the normal direction was 2140 cd/m² and a sufficiently high luminance was obtained. Similarly, according to a backlight unit 15 that is constructed by stacking two diffusion sheets 26A and 26B having diffusion properties with a haze value of 87.5%, the luminance in the normal direction was 2145 cd/m² and a sufficiently high luminance was obtained. Similarly, according to a backlight unit 15 that is constructed by stacking two diffusion sheets 26A and 26B having diffusion properties with a haze value of 78.5%, the luminance in the normal direction was 2148 cd/m² and a sufficiently high luminance was obtained.

As is understood from the above results, it is desirable that the backlight unit 15 adopt a structure wherein a plurality of diffusion sheets are combined and stacked, which have a haze value (including a manufacturing error (±4%)) that is set between 74% and 93%, preferably between 78% and 90%, more preferably between 78.5% and 89.3%. Thereby, a higher luminance and a wider viewing angle can more easily be achieved.

In the meantime, the luminance of the backlight unit including the lens layer also varies depending on the angle that is formed between the direction of extension of the prism shapes on the lens layer and the major radiation direction of radiation light from the light sources. Specifically, when the third optical function layer 27 is disposed on the second optical function layer 26, an angle θ (deg.) is set between the direction of extension of the prism shapes (i.e. first direction A in FIG. 4) and the major radiation direction of the light-emitting diodes that are the light sources (i.e. direction D in FIG. 2) in the major plane of the backlight unit 15 (i.e. the plane defined by the horizontal direction H and vertical direction V in FIG. 2). In this case, the luminance of the backlight unit 15, which is constructed by stacking the two diffusion sheets, varies depending on the angle θ, for example, as shown in FIG. 11.

On the basis of the above result, it is understood that the lens layer should preferably be disposed so as to set the formed angle θ at about 90°. Thereby, a higher luminance and a wider viewing angle can more easily be realized.

In FIG. 11, L1 indicates a luminance distribution in the case where an ESR (manufactured by 3M Limited) with a multilayer structure, which is formed of a polyester resin, is used as the first optical function layer 25, and L2 indicates a luminance distribution in the case where a 37W01 layer (manufactured by REIKO Co., Ltd.), which has a reflective surface formed by deposition of silver, is used as the first optical function layer 25. The 37W01 layer is less expensive than the ESR. However, as shown in FIG. 11, the 37W01 has a lower reflectance than the ESR, and the luminance obtained by the 37W01 is lower than that obtained by the ESR by about 5%.

However, it was confirmed that even in the case of using the 37W01, a decrease in luminance due to the use of the 37W01 can be compensated by optimizing the angle θ that is formed between the direction of extension of the prism shapes on the lens layer and the major radiation direction of the light sources, and substantially the same luminance as in the case of using the ESR can be obtained. As is clear from the result shown in FIG. 11, it was confirmed that the substantially the same luminance (about 2000 cd/m² or more in this example) as in the case of using the ESR was successfully obtained in the range of the formed angle θ of 90°±40°.

On the basis of the above result, it is understood that the lens layer should preferably be disposed so as to set the formed angle θ at 90°±40°. Thereby, reduction in cost, as well as a higher luminance and a wider viewing angle, can be realized.

In the case of combining the above-described backlight unit 15 with the liquid crystal display panel 2, if the direction of extension of the prism shapes is set to be parallel to the pixel rows PL and pixel columns PC that are composed of display pixels PX arranged in the effective display section 6, moiré may occur on the display screen. It is desirable, therefore, that the direction of extension of the prism shapes be non-parallel to the pixel rows PL and pixel columns PC.

Thereby, a liquid crystal display device, which has a high display quality as well as the above-described advantages of the backlight unit, can be provided.

The present invention is not limited to the above-described embodiments. In practice, the structural elements can be modified without departing from the spirit of the invention. Various inventions can be made by properly combining the structural elements disclosed in the embodiments. For example, some structural elements may be omitted from all the structural elements disclosed in the embodiments. Furthermore, structural elements in different embodiments may properly be combined.

For example, in the above-described embodiments, the light-emitting diodes are used as the light sources of the area light source device. Alternatively, an elongated tubular light source such as a cold-cathode fluorescent lamp may be used. In this case, the tubular light source is disposed so as to face the first side surface 21a of light guide 21 substantially in parallel. The major radiation direction of radiation light from the tubular light source intersects at right angles with the direction of extension of the tubular light source.

In the above embodiments, the area light source device is constructed as a backlight unit. Alternatively, the area light source device may be constructed as a front light unit. In the case of a liquid crystal display device including the area light source device that is constructed as a front light unit, the liquid crystal display panel is configured to include pixel electrodes with light reflectivity. In other words, the liquid crystal display device according to the embodiments can be constructed as a reflective liquid crystal display device that selectively reflects emission light from the front light unit, thereby displaying an image.

What is claimed is:

1. An area light source device comprising:
a light source;
a light guide having an incidence surface on which radiation light from the light source is incident, and a first major surface and a second major surface, which are opposed to each other and from which incident light coming in through the incidence surface is emitted;
a first optical function layer that is disposed on the second major surface side of the light guide and has light reflectivity;
a second optical function layer that is disposed on the first major surface side of the light guide and is constructed by stacking a plurality of diffusion sheets with light diffusing properties; and
a third optical function layer that is disposed on the second optical function layer and has a light collecting function.

2. The area light source device according to claim 1, wherein an air layer is interposed between the diffusion sheets that constitute the second optical function layer.

3. The area light source device according to claim 1, wherein each of the diffusion sheets has a haze value of between 74% and 93%.

4. The area light source device according to claim 1, wherein a principal incidence angle of light, which emerges from the second optical function layer and is incident on the third optical function layer, is between 15° and 30°.

5. The area light source device according to claim 1, wherein the light source is a light-emitting diode having an emission surface disposed to face the incidence surface of the light guide.

6. The area light source device according to claim 1, wherein the third optical function layer has a prism surface on which a plurality of prism shapes are juxtaposed, and an angle, which is formed between a direction of extension of the prism shapes and a major radiation direction of radiation light from the light source, is set to be 90°±40° on the second optical function layer.

7. A liquid crystal display device comprising:
a liquid crystal display panel including an effective display section in which a plurality of display pixels are arranged; and
an area light source device that illuminates the liquid crystal display panel, the area light source device including:
a light source;
a light guide having an incidence surface on which radiation light from the light source is incident, and a first major surface and a second major surface, which are opposed to each other and from which incident light coming in through the incidence surface is emitted;
a first optical function layer that is disposed on the second major surface side of the light guide and has light reflectivity;
a second optical function layer that is disposed on the first major surface side of the light guide and is constructed by stacking a plurality of diffusion sheets with light diffusing properties; and
a third optical function layer that is disposed on the second optical function layer and has a light collecting function.

8. The liquid crystal display device according to claim 7, wherein the third optical function layer has a prism surface on which a plurality of prism shapes are juxtaposed, and an angle, which is formed between a direction of extension of the prism shapes and a major radiation direction of radiation light from the light source, is set to be 90°±40° on the second optical function layer.

9. The liquid crystal display device according to claim 8, wherein the direction of extension of the prism shapes on the third optical function layer is non-parallel to pixel rows and pixel columns that are composed of the display pixels arranged in the effective display section.
